(19) United States
(12) Patent Application Publication
(10) Pub. No.: US 2026/0304125 A1
(43) Pub. Date: Oct. 1, 2026

(54) Context Control Transfer in a Communication Network

(71) Applicant: Telefonaktiebolaget LM Ericsson (publ), Stockholm (SE)

(72) Inventors: Karl Norrman, Stockholm (SE); Gunnar Mildh, Sollentuna (SE); Paul Schliwa-Bertling, Ljungsbro (SE)

(21) Appl. No.: 19/479,527

(22) PCT Filed: May 29, 2023
(86) PCT No.: PCT/EP2023/064337

§ 371 Date: Oct. 28, 2025

(51) Int. Cl. H04W 12/084; H04L 9/32; H04W 12/03

(52) U.S. Cl. CPC H04W 12/084; H04L 9/3213; H04W 12/03; H04L 2209/80

(57) ABSTRACT

A delegator network node (16D) in a communication network (10) delegates, to a controller network node (16C) in the network, control of a context (14) for a communication device (12). The delegator network node (16D) receives, from an assertee network node (16A) in the network, an assertion (26) that control of the context (14) has been transferred from the controller network node (16C) to assertee network node (16A). The delegator network node (16D) receives, from assertee network node (16A), in support of the assertion (26), a proof of transfer token (22) purporting to be cryptographic proof that controller network node (16C) endorsed transferring control of the context (14) to assertee network node (16A). The delegator network node (16D) attempts to validate the token (22) as being cryptographic proof that controller network node (16C) endorsed transferring control of the context (14) to assertee network node (16A). The delegator network node (16D) accepts or rejects the assertion (26) based on whether or not the token (22) is validated.

### TECHNICAL FIELD

The present application relates generally to a communication network, and relates more particularly to transferring control of a context in such a communication network.

### BACKGROUND

When a communication device connects to a communication network, the communication network establishes a so-called context for the communication device. The context includes information for providing communication service to the communication device. The context may for example include information about a state of the communication device, information for securing a connection with the communication device, information about capabilities of the communication device, information about identifiers associated with the communication device, etc. The communication network may maintain the context for the communication device for the lifetime of the communication device's connection, whereupon the context is released.

The network node that controls a communication device's context may change over time, e.g., with mobility of the communication device in the communication network. Control of the communication device's context includes control of the establishment, maintenance, and release of the context.

In one practical example of this, when a communication device hands over from a source base station to a target base station, the source base station transfers control of the communication device's context to the target base station. In another example, when a communication device in an idle state enters a new tracking area of a 5G network, control of the communication device's context is transferred from a source access and mobility function (AMF) to a target AMF, e.g., as described in 3GPP TS 23.502 V18.0.0.

In known approaches to transferring control of a communication device's context, the source network node sends the target network node a context identity that identifies the context, e.g., where the context identity may simply be based on a sequence number or counter. Possession of this context identity enables the target network node to control the context. Problematically, though, if a compromised node guesses or otherwise acquires the context identifier, the compromised node can maliciously hijack the context and even trick other nodes into believing that it is the legitimate controller of the context. The compromised node could then cause denial of service to the communication device or other network nodes, eavesdrop sensitive data associated with the communication device, pollute machine learning training or predictions, and otherwise jeopardize network performance. Challenges exist then in how to safeguard the communication network against these security risks while still allowing control of a communication device's context to be transferred between nodes.

### SUMMARY

Some embodiments herein cryptographically secure the transfer of control of a context for a communication device between nodes in a communication network. The source network node that transfers control of the context to a target network node provides the target network node with cryptographic proof that the source network node endorsed the transfer. The cryptographic proof may for instance take the form of a token which is cryptographically signed by the source network node and which cryptographically binds an identifier of the context with an identifier of the targe network node. This way, the target network node can present the cryptographic proof to other network nodes in support of its assertion that it now controls the context. Other network nodes may accordingly condition acceptance of the assertion on validation of the cryptographic proof. Some embodiments thereby enable network nodes to reject a spurious assertion from a compromised network node maliciously asserting that it controls a context for a communication device. These and other embodiments may advantageously safeguard against denial of service attacks, sensitive data leaks, pollution of machine learning training or predictions, and/or network performance degradation.

More particularly, embodiments herein include a method performed by a delegator network node in a communication network. The method comprises delegating, to a controller network node in the communication network, control of a context for a communication device. The method also comprises receiving, from an assertee network node in the communication network, an assertion that control of the context has been transferred from the controller network node to the assertee network node. The method also comprises receiving, from the assertee network node, in support of the assertion, a proof of transfer token purporting to be cryptographic proof that the controller network node endorsed transferring control of the context to the assertee network node. The method also comprises attempting to validate the proof of transfer token as being cryptographic proof that the controller network node endorsed transferring control of the context to the assertee network node. The method also comprises accepting or rejecting the assertion based on whether or not the proof of transfer token is validated.

In some embodiments, attempting to validate the proof of transfer token comprises attempting to validate the proof of transfer token as being a cryptographic binding, endorsed by the controller network node, between an identifier of the context and an identifier of the assertee network node.

In some embodiments, attempting to validate the proof of transfer token comprises attempting to validate that the proof of transfer token is cryptographically bound to the same context whose control is asserted by the assertion. In some embodiments, attempting to validate the proof of transfer token comprises attempting to validate that the proof of transfer token is cryptographically bound to the same assertee network node from whom the assertion and the proof of transfer token are received. In some embodiments, attempting to validate the proof of transfer token comprises attempting to validate that the proof of transfer token was endorsed by the same controller network node to whom control of the context was delegated. In some embodiments, attempting to validate that the proof of transfer token was endorsed by the same controller network node to whom control of the context was delegated comprises attempting to validate that the proof of transfer token was cryptographically signed by the same controller network node to whom control of the context was delegated. In some embodiments, attempting to validate that the proof of transfer token was cryptographically signed by the same controller network node to whom control of the context was delegated comprises attempting to validate that the proof of transfer token was cryptographically signed by the controller network node. In some embodiments, validating that the proof of transfer token was cryptographically signed by the controller network node uses a public key of the controller network node. In other embodiments, validating that the proof of transfer token was cryptographically signed by the controller network node uses a symmetric key provided to the controller network node and obtainable by the delegator network node in association with an identifier of the context. In some embodiments, attempting to validate that the proof of transfer token is cryptographically bound to the same assertee network node from whom the assertion and the proof of transfer token are received comprises attempting to validate that the proof of transfer token was cryptographically signed by the same assertee network node from whom the assertion and the proof of transfer token were received. In other embodiments, attempting to validate that the proof of transfer token is cryptographically bound to the same assertee network node from whom the assertion and the proof of transfer token are received comprises attempting to validate that the proof of transfer token was received over a secure channel associated with the same assertee network node from whom the assertion and the proof of transfer token were received.

In some embodiments, the method further comprises obtaining a proof of delegation token purporting to be cryptographic proof that the delegator network node delegated control of the context to the controller network node. In some embodiments, the method further comprises attempting to validate the proof of delegation token as being cryptographic proof that the delegator network node delegated control of the context to the controller network node, separately from or as part of attempting to validate the proof of transfer token. In some embodiments, accepting or rejecting the assertion comprises accepting or rejecting the assertion based also on whether or not the proof of delegation token is validated.

In some embodiments, attempting to validate the proof of transfer token comprises obtaining inputs that include a context identifier identifying the context whose control is asserted by the assertion and an assertee identifier identifying the assertee network node to whom control of the context has been transferred according to the assertion. In some embodiments, attempting to validate the proof of transfer token comprises obtaining a cryptographic key that is associated with the context, that is associated with the controller network node to whom control of the context was transferred, or that accompanies the proof of transfer token. In some embodiments, attempting to validate the proof of transfer token comprises generating a test value as a function of the inputs and the cryptographic key. In some embodiments, attempting to validate the proof of transfer token comprises obtaining an expected value from the proof of transfer token. In some embodiments, attempting to validate the proof of transfer token comprises validating or invalidating the proof of transfer token based respectively on whether or not the test value matches the expected value. In some embodiments, the inputs also include a proof of delegation token purporting to be cryptographic proof that the delegator network node delegated control of the context to the controller network node. In some embodiments, generating the test value comprises computing a cryptographic signature over the inputs using the cryptographic key. In some embodiments, the inputs also include a controller identifier identifying the controller network node from which control of the context was transferred according to the assertion.

In some embodiments, the method further comprises, based on accepting the assertion, performing an operation on a resource associated with the context. In some embodiments, the method further comprises receiving, from the assertee network node, a request for the delegator network node to perform the operation on the resource associated with the context, wherein the proof of transfer token is included in the request. In some embodiments, the resource is a user plane traffic flow for the communication device or a control plane session for the communication device. In some embodiments, the operation on the resource includes redirecting the resource from the controller network node to the assertee network node. In some embodiments, the resource is a log or registry at the delegator network node, and wherein the operation on the resource includes logging, on the resource, transfer of control of the context to the assertee network node.

In some embodiments, the delegator network node implements a Session Management Function, SMF, serving the communication device, and the controller network node and the assertee network node each implement a respective Access and Mobility Management Function, AMF. In other embodiments, the delegator network node implements a core network node serving the communication device, and the controller network node and the assertee network node are each an access network node.

Other embodiments herein include a method performed by a controller network node in a communication network. The method comprises obtaining, from a delegator network node in the communication network, delegation of control of a context for a communication device. The method also comprises transferring control of the context to an assertee network node in the communication network. The method also comprises endorsing a proof of transfer token as cryptographic proof that the controller network node endorsed transferring control of the context to the assertee network node. The method also comprises sending the proof of transfer token to the assertee network node.

In some embodiments, endorsing the proof of transfer token comprises endorsing the proof of transfer token as a cryptographic binding between an identifier of the context and an identifier of the assertee network node.

In some embodiments, endorsing the proof of transfer token comprises cryptographically signing the proof of transfer token. In some embodiments, cryptographically signing the proof of transfer token comprises cryptographically signing the proof of transfer token using a private key of the controller network node. In other embodiments, cryptographically signing the proof of transfer token comprises cryptographically signing the proof of transfer token using a symmetric key that the controller network node provides to the assertee network node.

In some embodiments, the method further comprises obtaining a proof of delegation token purporting to be cryptographic proof that the delegator network node delegated control of the context to the controller network node. In some embodiments, endorsing the proof of transfer token comprises endorsing the proof of transfer token using the proof of delegation token. In other embodiments, the method further comprises sending the proof of delegation token to the assertee network node.

In some embodiments, endorsing the proof of transfer token comprises obtaining inputs that include a context identifier identifying the context and an assertee identifier identifying the assertee network node. In some embodiments, endorsing the proof of transfer token comprises obtaining a cryptographic key that is associated with the context, that is associated with the controller network node, or that is received from the delegator network node. In some embodiments, endorsing the proof of transfer token comprises endorsing the proof of transfer token as a function of the inputs and the cryptographic key. In some embodiments, the inputs also include a proof of delegation token as cryptographic proof that the delegator network node delegated control of the context to the controller network node. In some embodiments, endorsing the proof of transfer token comprises computing a cryptographic signature over the inputs using the cryptographic key.

In some embodiments, the delegator network node implements a Session Management Function, SMF, serving the communication device, and the controller network node and the assertee network node each implement a respective Access and Mobility Management Function, AMF. In other embodiments, the delegator network node implements a core network node serving the communication device, and the controller network node and the assertee network node are each an access network node.

Other embodiments herein include a method performed by an assertee network node in a communication network. The method comprises obtaining, from a controller network node in the communication network, a proof of transfer token as cryptographic proof that the controller network node endorsed transferring control of a context for a communication device to the assertee network node. The method also comprises transmitting, to a delegator network node that had delegated control of the context to the controller network node, an assertion that control of the context has been transferred from the controller network node to the assertee network node. The method also comprises transmitting the proof of transfer token to the delegator network node in support of the assertion.

In some embodiments, the proof of transfer token comprises a cryptographic binding, created or endorsed by the controller network node, between an identifier of the context and an identifier of the assertee network node.

In some embodiments, the method further comprises transmitting, to the delegator network node, in support of the assertion, a proof of delegation token purporting to be cryptographic proof that the delegator network node delegated control of the context to the controller network node.

In some embodiments, transmitting the proof of transfer token to the delegator network node comprises transmitting the proof of transfer token to the delegator network node in a request for the delegator network node to perform an operation on a resource associated with the context. In some embodiments, the resource is a user plane traffic flow for the communication device or a control plane session for the communication device. In some embodiments, the operation on the resource includes redirecting the resource from the controller network node to the assertee network node. In some embodiments, the resource is a log or registry at the delegator network node, and the operation on the resource includes logging, on the resource, transfer of control of the context to the assertee network node.

In some embodiments, the delegator network node implements a Session Management Function, SMF, serving the communication device, and wherein the controller network node and the assertee network node each implement a respective Access and Mobility Management Function, AMF. In other embodiments, the delegator network node implements a core network node serving the communication device, and wherein the controller network node and the assertee network node are each an access network node.

Other embodiments herein include a delegator network node in a communication network. The delegator network node comprises communication circuitry and processing circuitry. The processing circuitry is configured to delegate, to a controller network node in the communication network, control of a context for a communication device. The processing circuitry is also configured to receive, from an assertee network node in the communication network, an assertion that control of the context has been transferred from the controller network node to the assertee network node. The processing circuitry is also configured to receive, from the assertee network node, in support of the assertion, a proof of transfer token purporting to be cryptographic proof that the controller network node endorsed transferring control of the context to the assertee network node. The processing circuitry is also configured to attempt to validate the proof of transfer token as being cryptographic proof that the controller network node endorsed transferring control of the context to the assertee network node. The processing circuitry is also configured to accept or reject the assertion based on whether or not the proof of transfer token is validated.

In some embodiments, the processing circuitry is configured to perform the steps described above for a delegator network node.

Other embodiments herein include a controller network node in a communication network. The controller network node comprises communication circuitry and processing circuitry. The processing circuitry is configured to obtain, from a delegator network node in the communication network, delegation of control of a context for a communication device. The processing circuitry is also configured to transfer control of the context to an assertee network node in the communication network. The processing circuitry is also configured to endorse a proof of transfer token as cryptographic proof that the controller network node endorsed transferring control of the context to the assertee network node. The processing circuitry is also configured to send the proof of transfer token to the assertee network node.

In some embodiments, the processing circuitry is configured to perform the steps described above for a controller network node.

Other embodiments herein include an assertee network node in a communication network. The assertee network node comprises communication circuitry and processing circuitry. The processing circuitry is configured to obtain, from a controller network node in the communication network, a proof of transfer token as cryptographic proof that the controller network node endorsed transferring control of a context for a communication device to the assertee network node. The processing circuitry is also configured to transmit, to a delegator network node that had delegated control of the context to the controller network node, an assertion that control of the context has been transferred from the controller network node to the assertee network node. The processing circuitry is also configured to transmit the proof of transfer token to the delegator network node in support of the assertion.

In some embodiments, the processing circuitry is configured to perform the steps described above for an assertee network node.

In some embodiments, a computer program comprising instructions which, when executed by at least one processor of a network node, causes the network node to perform the steps described above for a network node. In some embodiments, carrier containing the computer program is one of an electronic signal, optical signal, radio signal, or computer readable storage medium.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a communication network configured to serve a communication device according to some embodiments.

FIG. 2 is a block diagram of network nodes configured for transferring control of a context of a communication device using a proof of transfer token according to some embodiments.

FIG. 3 is a block diagram of an endorser configured to endorse a proof of transfer token according to some embodiments.

FIG. 4A is a block diagram of a proof of transfer token according to some embodiments.

FIG. 4B is a block diagram of signaling for conveying a proof of transfer token according to other embodiments.

FIG. 5 is a block diagram of a delegator network node according to some embodiments.

FIG. 6 is a block diagram of network nodes configured for transferring control of a context of a communication device using a proof of transfer token as well as a proof of delegation token according to other embodiments.

FIG. 7 is a block diagram of network nodes configured for transferring control of a context of a communication device according to some embodiments.

FIG. 8 is a call flow diagram for transferring control of a context of a communication device according to some embodiments.

FIG. 9 is a call flow diagram for transferring control of a context of a communication device according to other embodiments.

FIG. 10 is a logic flow diagram of a method performed by a delegation network node according to some embodiments.

FIG. 11 is a logic flow diagram of a method performed by a controller network node according to some embodiments.

FIG. 12 is a logic flow diagram of a method performed by an assertion network node according to some embodiments.

FIG. 13 is a block diagram of a delegation network node according to some embodiments.

FIG. 14 is a block diagram of a controller network node according to some embodiments.

FIG. 15 is a block diagram of an assertion network node according to some embodiments.

FIG. 16 shows an example of a communication system in accordance with some embodiments.

FIG. 17 is a block diagram of a host which may be an embodiment of the host of FIG. 16, in accordance with various aspects described herein.

FIG. 18 is a block diagram illustrating a virtualization environment in which functions implemented by some embodiments may be virtualized.

FIG. 19 shows a communication diagram of a host communicating via a network node with a UE over a partially wireless connection in accordance with some embodiments.

### DETAILED DESCRIPTION

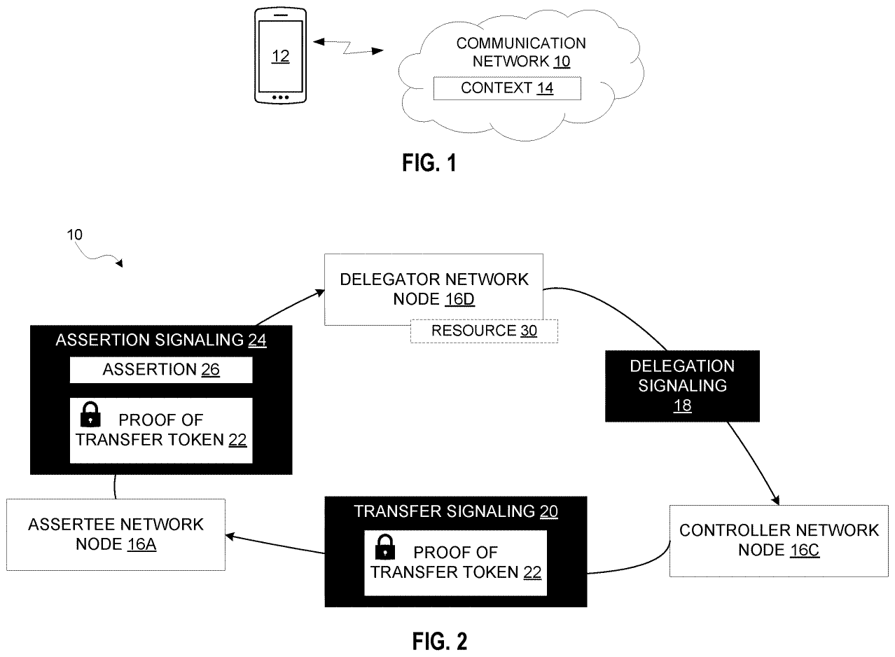

As shown in FIG. 1, a communication network 10 provides communication service to a communication device 12, e.g., a user equipment (UE). The communication network 10 may for example be a 5G network that provides a wireless communication service to the communication device 12.

When the communication device 12 connects to the communication network 10, the communication network 10 establishes a so-called context 14 for the communication device 12. The context 14 includes information for providing communication service to the communication device 12. The context 14 may for example include information about a state of the communication device 12, information for securing a connection with the communication device 12, information about capabilities of the communication device 12, information about identifiers associated with the communication device 12, etc. In these and other embodiments, the information in the context 14 may include information for an access stratum (AS) connection with the communication device 12 and/or information for a non-access stratum (NAS) connection with the communication device 12. Either way, the communication network 10 may maintain the context 14 for the communication device 12 for the lifetime of the communication device's connection, whereupon the context 14 is released.

FIG. 2 shows embodiments for transferring control of the context 14 for the communication device 12 between different nodes in the communication network 10. As shown, a delegator network node 16D has nominal or initial control of the context 14 for the communication device 12. Control of the context 14 in this regard encompasses control of the establishment, use, maintenance, and/or release of the context 14. Use of the context 14 may for example include using parameter(s) stored in the context 14 as input to any process that an entity controlling the context 14 is involved in for a communication link with the communication device 12, e.g., packet processing, signaling related to mobility, policies, services, etc. Use of the context 14 in one specific example may include encrypting data using a key stored in the context 14. Maintenance of the context 14 may involve modifying data in the context 14, e.g., changing one or more configuration parameters related to a communication link with the communication device 12.

At some point, though, the delegator network node 16D delegates control of the context 14 to another network node, referred to as a controller network node 16C. As shown in FIG. 2 in this regard, the delegator network node 16D transmits delegation signaling 18 to the controller network node 16C as part of a procedure for delegating control of the context 14 to the controller network node 16C. The delegation signaling 18 may for instance include a UE context setup message for setting up the context 14 at the controller network node 16C. Or, when a packet data unit (PDU) session is setup, the delegation signaling 18 may include a message to allow a different network node to take over the PDU session at a later stage. Regardless, having obtained control of the context 14 via such delegation, the controller network node 16C is authorized or entrusted to control the context 14, on behalf of or instead of the delegator network node 16D.

The controller network node 16C thereafter transfers control of the context 14 to yet another network node, referred to as an assertee network node 16A. With the assertee network node 16A being the target of the transfer, in some embodiments the controller network node 16C is referred to as the source network node of the transfer and the assertee network node 16A is referred to as the target network node of the transfer. In any event, the controller network node 16C may transfer control of the context 14 by transmitting transfer signaling 20 to the assertee network node 16A. In some embodiments, the transfer signaling 20 includes information about the context 14 being transferred, such as an identifier of the context 14. In one or more embodiments, the controller network node 16C autonomously transfers control of the context 14 to the assertee network node 16A, without involvement or approval of the delegator network node 16D, e.g., so that the delegator network node 16D remains ignorant of the transfer.

Now in control of the context 14, the assertee network node 16 may assert its control of the context 14 in its interaction with other network nodes. As shown in FIG. 2, the assertee network node 16 does this by transmitting assertion signaling 24 to the delegator network node 16D. The assertion signaling 24 includes an assertion 26 asserting that control of the context 14 has been transferred to the assertee network node 16A, e.g., from the controller network node 16C. In some embodiments, the assertion 26 is explicit in that the assertee network node 16 directly claims to have control of the context 14. In other embodiments, the assertion 26 is implicit in that the assertee network node 16, via the assertion signaling 24, operates as if the assertee network node 16 has control of the context 14. The assertion signaling 24 may for example include a request for the delegator network node 16D to perform an operation associated with the context 14, e.g., to perform an operation on a resource 30 associated with the context 14 according to a rule or policy, with the delegator network node 16D accepting that request only from a network node that has control of the context 14. By making such a request, then, the assertee network node 16 implicitly asserts that it has control of the context 14.

According to some embodiments, though, the delegator network node 16D requires the assertee network node 16A to prove its assertion 26 before the delegator network node 16D acts on that assertion 26, as opposed to simply accepting an unsubstantiated assertion 26. Indeed, especially in embodiments where the delegator network node 16D remains ignorant of the controller network node's autonomous decision to transfer control of the context 14, the delegator network node 16D requires that the assertion 26 be substantiated with proof. The proof that the delegator network node 16D requires in some embodiments is proof that the controller network node 16C endorsed transferring control of the context 14 to the assertee network node 16A, i.e., proof that the controller network node 16C authorized or approved control of the context 14 to be transferred to the assertee network node 16A. The delegator network node 16D in this case operates on the assumption that, if the controller network node 16C endorsed transferring control of the context 14 to the assertee network node 16A, the assertee network node 16A obtained control of the context 14 legitimately, rather than having maliciously obtained control of the context 14 by hijacking it.

Notably according to some embodiments, then, the controller network node 16C equips the assertee network node 16A with a so-called proof of transfer (POT) token 22, e.g., via the transfer signaling 20. The proof of transfer token 22 serves as cryptographic proof that the controller network node 16C endorsed transferring control of the context 14 to the assertee network node 16A. Note here that the proof of transfer token 22 proves not just that control of the context 14 has been transferred to the assertee network node 16A but that the controller network node 16C endorsed such transfer. That is, the proof of transfer token 22 establishes the truth that the controller network node 16C endorsed transferring control of the context 14 to the assertee network node 16A. The proof of transfer token 22 serves as proof that is cryptographic in nature in the sense that the proof is cryptographically verifiable by other network nodes, e.g., with a cryptographic secret or keying material. The controller network node 16C may for example cryptographically sign the proof of transfer token 22 as its endorsement of whatever the proof of transfer token 22 indicates, namely that control of a certain context 14 has been transferred to a certain assertee network node 14, in which case cryptographic verification of the controller network node's signature amounts to cryptographic verification of the proof of transfer token 22. In these and other embodiments, the proof of transfer token 22 may cryptographically bind the context 14 to the assertee network node 16A in such a way that the proof of transfer token 22 proves to the delegator network node 16D that it reflects a decision only the controller network node 16C could have made. The proof of transfer token 22 accordingly equips the assertee network node 16A with the ability to prove to the delegator network node 16D that the assertee network node 16A obtained control of the context 14 legitimately from the controller network node 16C.

FIG. 2 in this regard shows that the assertee network node 16A provides the proof of transfer token 22 to the delegator network node 16D, in support of its assertion 26. The assertee network node 16A may for example present the proof of transfer token 22 within or in association with the assertion signaling 24, e.g., within a request for the delegator network node 16D to perform an operation on a resource 30 associated with the context 14. In receipt of the proof of transfer token 22, the delegator network node 16D attempts to validate the proof of transfer token 22. If the attempt succeeds such that the delegator network node 16D validates the proof of transfer token 22, the delegator network node 16D accepts the assertion 26 that control of the context 14 has been transferred to the assertee network node 16A. If on the other hand the attempt fails such that the delegator network node 16D cannot validate the proof of transfer token 22, the delegator network node 16D rejects the assertion 26.

Acceptance or rejection of the proof of transfer token 22 governs if or how the delegator network node 16D acts on the assertion 26. For example, acceptance or rejection of the proof of transfer token 22 may govern whether or not the delegator network node 16D performs an operation associated with the context 14 at the request of the assertee network node 16A. For example, in embodiments where the assertee network node 16A makes its assertion 26 in association with requesting the delegator network node 16D to perform an operation, e.g., on a resource 30 associated with the context 14, the delegator network node 16D selectively performs that operation depending on whether or not the proof of transfer token 22 is validated. In these and other embodiments, the proof of transfer token 22 enables the delegator network node 16D to reject a spurious assertion from a compromised network node maliciously asserting that it controls the context 14 for the communication device 12. These and other embodiments may therefore advantageously safeguard against denial of service attacks, sensitive data leaks, pollution of machine learning training or predictions, and/or network performance degradation.

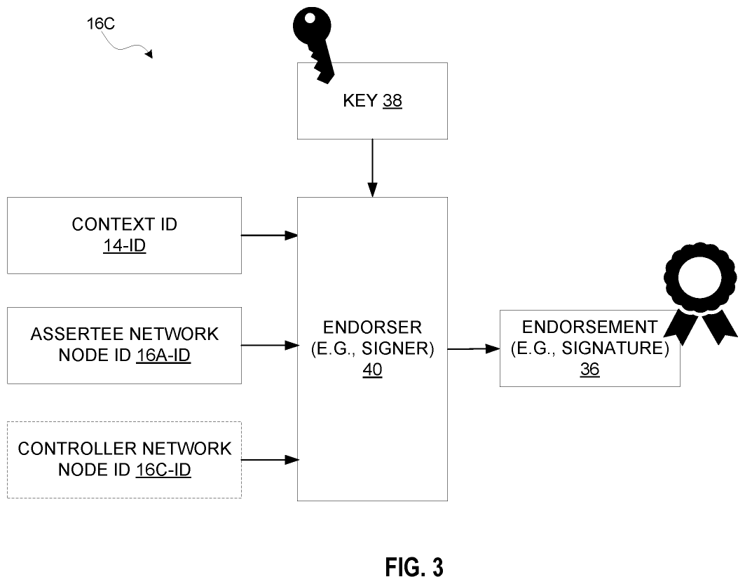

FIG. 3 shows additional details for generating the proof of transfer token 22 according to some embodiments. As shown, the controller network node 16C includes an endorser 40 configured to generate an endorsement 36, e.g., in the form of a cryptographic signature, that is to comprise, or be included in, the proof of transfer token 22. The endorser 40 obtains, as inputs, a context identifier 14-ID identifying the context 14 and an assertee identifier 16A-ID identifying the assertee network node 16A. As an option in one embodiment, the endorser 40 may also obtain, as an input, a controller identifier 16C-ID identifying the controller network node 16C. The identifier identifying a network node, e.g., 16A-ID or 16C-ID, may for instance be a logical node identifier, a network function identifier identifying a network function (NF) associated with the node, an instance identifier identifying a hardware or software instance associated with the node, a uniform resource identifier (URI) or uniform resource locator (URL) pointing to the node, an Internet Protocol (IP) address or Ethernet address of the node, a cell identifier identifying a cell served by the node, a tracking area identifier identifying a tracking area associated with the node, a public land mobile network (PLMN) identifier identifying a PLMN to which the node belongs, a network slice identifier identifying a network slice to which the node belongs, or any other identifier that uniquely and/or unambiguously identifies the node within an applicable domain.

Regardless, the endorser 40 further obtains a cryptographic key 38. This cryptographic key 38 may be associated with the context 14, so as to be context-specific. Alternatively or additionally, the cryptographic key 38 may be associated with the controller network node 16C, so as to be node-specific. Regardless, in some embodiments, the controller network node 16C may generate or derive the cryptographic key 38 itself, or may receive the cryptographic key 38 from the delegator network node 16D.

In any event, the endorser 40 then generates the endorsement 36 as a function of the inputs 14-ID, 16A-ID and the cryptographic key 38. As shown, for instance, the endorser 40 generates the endorsement 36 as a function of the inputs 14-ID, 16A-ID, and optionally 16C-ID as well as the cryptographic key 38. Where the endorsement 36 is a cryptographic signature, for example, the endorser 40 may compute the cryptographic signature over the inputs using the cryptographic key 38. Creating the endorsement 36 in these or other ways may have the effect of cryptographically binding the endorsement 36 to the context 14, the assertee network node 16A, and/or the controller network node 16C.

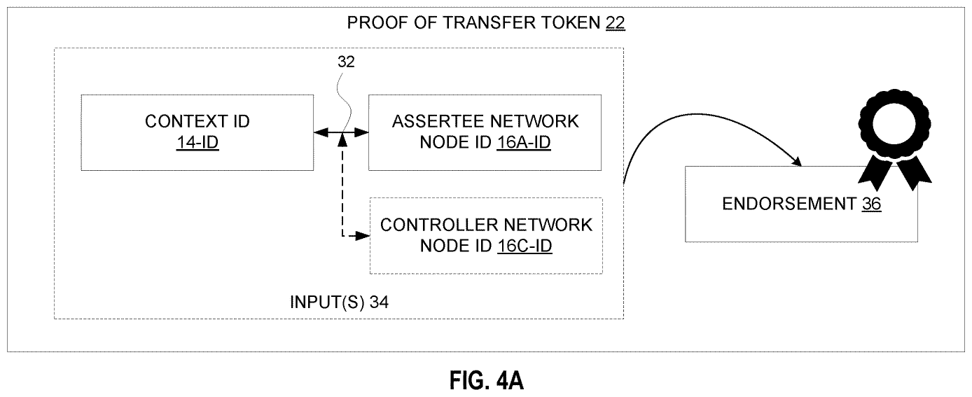

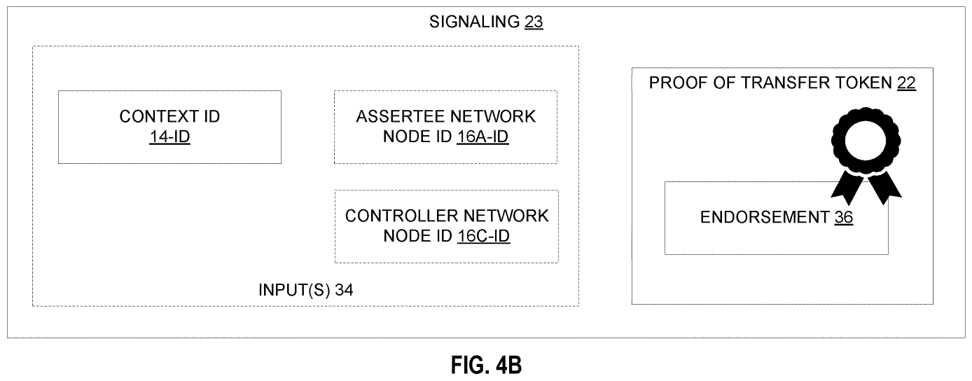

Consider now various possible implementations for how to include this endorsement 36 into the proof of transfer token 22. FIG. 4A shows one implementation where the endorsement 36 is included in the proof of transfer token 22 along with one or more inputs 34 based on which the endorsement 36 was computed. The input(s) 34 included in the proof of transfer token 22 may for example include the context identifier 14-ID, the assertee network node identifier 16A-ID, and/or the controller network node identifier 16C-ID. In these embodiments, then, the proof of transfer token 22 is broadly defined as being a package that contains the endorsement 36 and at least some of the input(s) 34 based on which the endorsement 36 was computed.

FIG. 4B by contrast shows an alternative implementation where the proof of transfer token 22 is more narrowly defined as including the endorsement 36, but not the input(s) 34 based on which the endorsement 36 was computed. Rather than the proof of transfer token 22 including the input(s) 34, then, those input(s) 34 may be conveyed via signaling 23 between network nodes, outside of the proof of transfer token 22. For example, where this signaling 23 is the transfer signaling 20 from the controller network node 16C, the transfer signaling 20 may convey the proof of transfer token 22 as well as the input(s) 34. As another example, where the signaling 23 is the assertion signaling 24, the assertion signaling 24 may convey the proof of transfer token 22 and also convey the input(s) 34, separate from or as part of the assertion 26.

In some embodiments, the input(s) 34 are included in the proof of transfer token 22 itself or in the assertion signaling 24 to the delegator network node 16D, so that the delegator network node 16C can use the input(s) 34 to validate the proof of transfer token 22. In some embodiments, for example, the delegator network node 16D reads or extracts the input(s) 34 from the proof of transfer token 22 or from the assertion signaling 24, and uses those input(s) 34 to attempt to validate the proof of transfer token 22, either by attempting to validate the proof of transfer token 22 as a whole or by attempting to validate the endorsement 36 within the proof of transfer token 22. In some embodiments, the delegator network node 16D attempts such validation by attempting to recreate the proof of transfer token 22 or the endorsement 36 using the input(s) 34, where successful recreation means the validation succeeds.

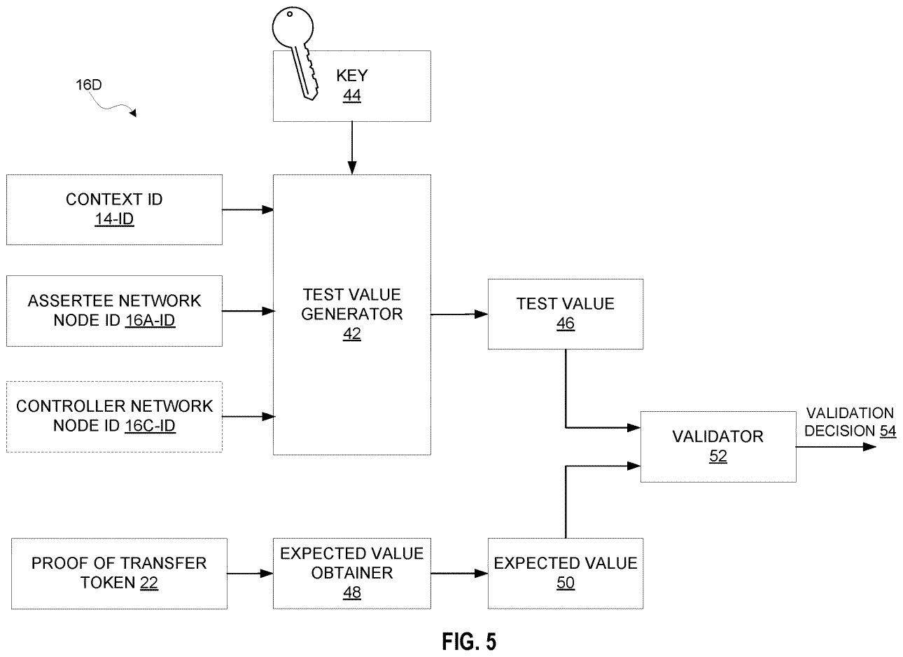

FIG. 5 shows one example of processing by the delegator network node 16D for attempting to validate the proof of transfer token 22. As shown, the delegator network node 16D includes a test value generator 42. The test value generator 42 obtains the input(s) 34 for generating a test value 46. The input(s) 34 may include the context identifier 14-ID, the assertee identifier 16A-ID, and/or the controller identifier 16C-ID, e.g., as read from the proof of transfer token 22 or the assertion signaling 24. The test value generator 42 also obtains a cryptographic key 44. The cryptographic key 44 may be the same key as the cryptographic key 38 used by the controller network node 16C to endorse the proof of transfer token 22, or may otherwise be associated with or correspond to that cryptographic key 38. In one embodiment, the cryptographic key 44 may be indicated in the proof of transfer token 22 or the assertion signaling 24. In any event, the test value generator 42 generates the test value 46 as a function of the input (34) and the cryptographic key 44.

The delegator network node 16D also includes an expected value obtainer 48. The expected value obtainer 48 obtains an expected value 50 from the proof of transfer token 22. The expected value obtainer 48 may simply read the expected value 50 from the proof of transfer token 22, or may derive or otherwise generate the expected value as a function of the proof of transfer token 22.

In some embodiments, for example, the expected value 50 is the proof of transfer token 22 itself as a whole. In this case, the test value generator 42 generates the test value 46 as a test proof of transfer token which is expected to match the expected value 50 if the proof of transfer token 22 is valid. In other embodiments, by contrast, the expected value 50 is the endorsement 36 within the proof of transfer token 22. In this case, the test value generator 42 generates the test value 46 as a test endorsement which is expected to match the endorsement 36 within the proof of transfer token 22 if the proof of transfer token 22 is valid.

Either way, the delegator network node 16D correspondingly includes a validator 52 that validates or invalidates the proof of transfer token 22 based respectively on whether or not the test value 46 matches the expected value 50. The validator 52 to this end compares the test value 46 to the expected value 50. If the test value 46 matches the expected value 50, the validator 52 outputs a validation decision 54 indicating that the proof of transfer token 22 is valid. Otherwise, if the test value 46 does not match the expected value 50, the validator 52 outputs a validation decision 54 indicating that the proof of transfer token 22 is invalid.

Note that, in one or more embodiments where the delegator network node 16D attempts to recreate the proof of transfer token 22 or the endorsement 36, the proof of transfer token 22 or the endorsement 36 need not be readable or transparent, e.g., as long as the delegator network node 16D is otherwise provided with the input(s) 34 and cryptographic key 44. In some embodiments, for example, the proof of transfer token 22 or the endorsement 36 is an opaque object that is indecipherable by its recipient, e.g., by the assertee network node 16A and/or the delegator network node 16D. In this case, the input(s) 34 may be communicated via signaling, outside of the proof of transfer token 22 or the endorsement 36.

These embodiments where the delegator network node 16D attempts to recreate the proof of transfer token 22 or the endorsement 36 may be particularly applicable where the proof of transfer token 22 is based on symmetric cryptography, i.e., where the cryptographic key 38 used to create the proof of transfer token 22 is the same as the cryptographic key 44 used to validate the proof of transfer token 22. Indeed, in this case, the delegator network node 16D is given access to the cryptographic key so that the proof of transfer token 22 or the endorsement 36 can be recreated, e.g., the controller network node 16C may signal the cryptographic key 38 to the assertee network node 16A which may in turn signal the cryptographic key 38 to the delegator network node 16D.

In other embodiments based on asymmetric cryptography, though, the delegator network node 16D is not given access to the cryptographic key 38 used to create the proof of transfer token 22. For example, the cryptographic key 38 used to create the proof of transfer token is a private key of the controller network node 16C that is not shared with the assertee network node 16A or the delegator network node 16D. The delegator network node 16D accordingly cannot recreate the proof of transfer token 22 without such access. However, this private key is paired with a corresponding public key that is accessible to the delegator network node 16D. The public key may for instance be indexed with the controller network node identifier 16C-ID, so that the delegator network node 16D can retrieve the public key using that controller network node identifier 16C-ID. Either way, the delegator network node 16D in these embodiments nonetheless uses the cryptographic key 44 that is accessible to it, namely the public key corresponding to the private key used to create the proof of transfer token 22, in order to attempt to validate the proof of transfer token 22. The delegator network node 16D may do so for example by validating that the proof of transfer token 22 was endorsed by the controller network node 16C. Where the endorsement 36 is a cryptographic signature signed by the controller network node 16C with its private key, this entails authenticating the cryptographic signature with the corresponding public key.

No matter the particular implementation of the proof of transfer token 22, though, the delegator network node 16D in some embodiments effectively attempts to validate the proof of transfer token 22 as being a cryptographic binding, endorsed by the controller network node 16C, between the context identifier 14-ID and the assertee network node identifier 16A-ID. In doing so, the delegator network node 16D attempts to validate that (i) the proof of transfer token 22 is cryptographically bound to the same context 14 whose control is asserted by the assertion 26, and (ii) the proof of transfer token 22 is cryptographically bound to the same assertee network node 16A from whom the assertion 26 and the proof of transfer token 22 are received.

Note that verifying that the assertee network node sending the proof of transfer token 22 is the same assertee network node from whom the assertion 26 and the proof of transfer token 22 are received assumes that the delegator network node 16D can verify the source of the proof of transfer token 22. This may be accomplished for instance by the assertee network node 16A crypotographically signing the proof of transfer token 22, e.g., so that the delegator network node 16D attempts to validate that the proof of transfer token 22 was cryptographically signed by the same assertee network node from whom the assertion 26 and the proof of transfer token 22 were received. Alternatively or additionally, the proof of transfer token 22 may be communicated over a secure channel that provides authentication and message integrity, e.g., so that the delegator network node 16D attempts to validate that the proof of transfer token 22 was received over a secure channel associated with the same assertee network node 16D from whom the assertion 26 and the proof of transfer token 22 were received.

In some embodiments, the delegator network node 16D further attempts to validate that the proof of transfer token 22 was endorsed by the same controller network node 16C to whom control of the context 14 was delegated, e.g., by validating that the proof of transfer token 22 was cryptographically signed by the same controller network node 16C to whom control of the context 14 was delegated.

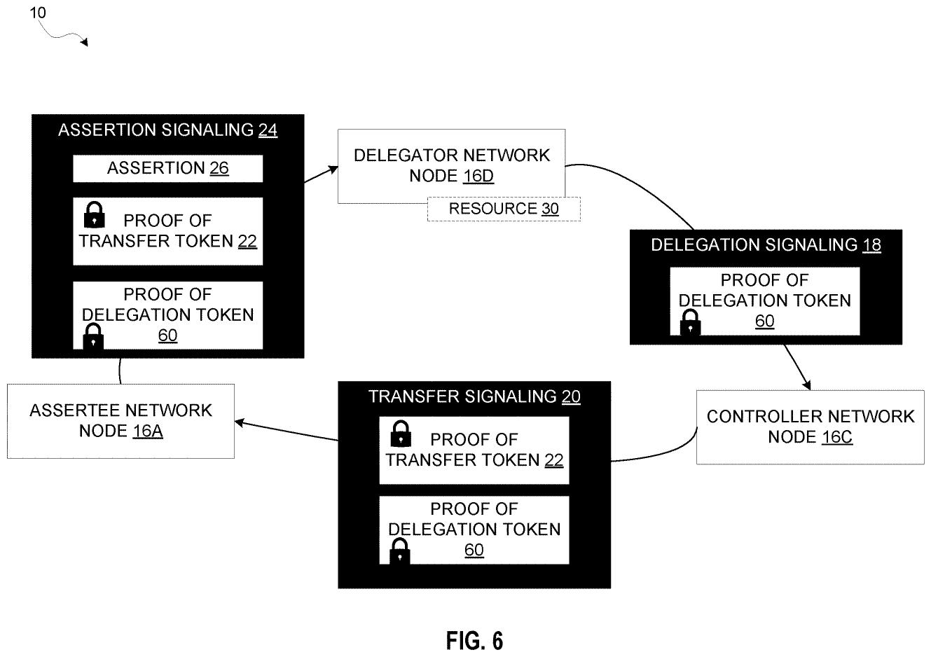

The proof of transfer token 22 as described so far has been agnostic as to which network node delegated control of the context 14 to the controller network node 16C. Some embodiments herein however further introduce a so-called proof of delegation (POD) token 60 as shown in FIG. 6. The proof of delegation token 60 is offered by the delegation network node 16D to the controller network node 16C, e.g., within delegation signaling 18, as cryptographic proof that the delegator network node 16D delegated control of the context 14 to the controller network node 14C. The proof of delegation token 60 may for instance cryptographically bind the context identifier 14-ID to the controller identifier 16C-ID. Regardless, the controller network node 16C may propagate this proof of delegation token 60 to the assertee network node 16A, which may in turn propagate the proof of delegation token 60 to the delegator network node 16D in support of its assertion 26. The delegator network node 16D may then attempt to validate the proof of delegation token 60 as being cryptographic proof that the delegator network node 16D indeed delegated control of the context 14 to the controller network node 16C. The delegator network node 16D accordingly accepts or rejects the assertion 26 from the controller network node 16C based also on whether or not the proof of delegation token 60 is validated.

Although FIG. 6 shows the proof of delegation token 60 as separate from the proof of transfer token 22, the proof of delegation token 60 may actually be separate from or subsumed within the proof of transfer token 22. In the latter case, the controller network node 16D may for example cryptographically bind the proof of delegation token 60 to the proof of transfer token 22, e.g., by including the proof of delegation token 60 as one of the input(s) 34 based on which the proof of transfer token 22 is computed or by otherwise endorsing the proof of transfer token 22 using the proof of delegation token 60. Where separate from the proof of transfer token 22, then, the delegator network node 16D may condition acceptance of the assertion 26 on separate validation of both the proof of transfer token 22 and the proof of delegation token 60. Where subsumed within the proof of transfer token 22, though, validation of the proof of transfer token 22 constitutes implicit validation of the proof of delegation token 60, such that the delegator network node 16D may just condition acceptance of the assertion 26 on validation of the proof of transfer token 22.

Consider now additional details of some embodiments herein with reference to some practical applications.

In one practical example, when the communication device 12 hands over from a source base station to a target base station, the source base station transfers control of the communication device's context 14 to the target base station. In this case, the source base station serves as the controller network node 16C and the target base station serves as the assertee network node 16C. And a core network node in a core network of the communication network 10 serves as the delegator network node 16D.

In another example, when the communication device 12 in an idle state enters a new tracking area, control of the communication device's context 14 is transferred from a source access and mobility function (AMF) to a target AMF, e.g., as described in 3GPP TS 23.502 V18.0.0. In this case, the source AMF serves as the controller network node 16C and the target AMF serves as the assertee network node 16C. And a Session Management Function (SMF) of the communication network 10 serves as the delegator network node 16D.

In these and other examples, the resource 30 associated with the context 14 may be a user plane traffic flow for the communication device 12 or a control plane session for the communication device 12. Upon validating the proof of transfer token 22, then, the delegator network node 16D may perform an operation on this resource 30 by redirecting the resource from the controller network node 16C to the assertee network node 16A.

Alternatively, the resource 30 may simply be a log or registry at the delegator network node 16D. In this case, the operation on the resource 30 may just include logging, on the resource 30, transfer of control of the context 14 to the assertee network node 16A.

Some embodiments herein thereby apply to situations in the communication network 120 where the delegator network node 16D has a resource 30 related to the communication device 12, e.g., an AMF controlling the resource of user-plane data-flows between the user plane function (UPF) and the communication device 12. This resource is associated with the context 14 for the communication device 12, which is controlled by the controller network node 16C, e.g., consider an AS UE context controlled by a (source) base station. The controller network node 16C may then transfer control of the context 14 over to the assertee network node 16A, e.g., in an X2/N2 handover to a target base station.

The assertee network node 16A may then report the transfer of context control to the delegator network node 16D. In the handover example, this corresponds to a PATH-SWITCH REQUEST from the target base station to the AMF. Rather than the delegator network node 16D just accepting such report given that the report contains the correct identity for the context 14, the delegator network node 16D in embodiments herein conditions acceptance of the report on validation of a proof of transfer token 22.

In another example, the communication device 12 is a UE in an IDLE state and is entering a new Tracking Area in which it is not registered. In this case, the communication device 12 initiates the Registration procedure. If the Registration procedure is performed towards a new AMF (step 3 in FIG. 1 from 3GPP TS 23.502 V18.0.0), the new AMF will contact the Session Management Function (SMF) (step 17) indicating that it has taken over the UE context from the old AMF (the context transfer is in step 5). The indication from the new AMF includes a Session Management (SM) Context ID that the new AMF received from the old AMF.

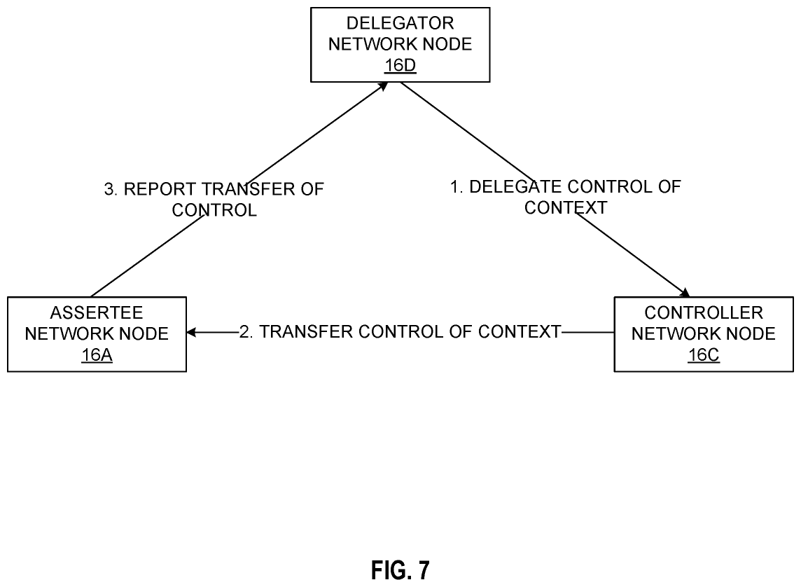

The procedures above are illustrated generally in FIG. 7, in line with the embodiments described above. The delegator network node 16D delegates control of the context 14 to the controller network node 16C (the context has an identifier that is signaled from delegator network node 16D to the controller network node 16C). The control of the context 14 is then transferred to the assertee network node 16A, which reports the transfer of control to the delegator network node 16D.

Some embodiments address a problem with these and other scenarios where a simple, counter-based context identifier does not itself provide sufficient protection against spurious assertions from compromised nodes asserting that control of a context has been transferred to them. Alternatively or additionally in these scenarios, some embodiments herein advantageously bind the context identifier to a particular target node to which control of the context is transferred.

Alternatively or additionally, some embodiments advantageously safeguard mobility procedures that depend on actions taken by the communication device 12. Examples of this are Packet Temporary Mobile Subscriber Identity (P-TMSI) signatures and NAS security tokens used to protect idle mode mobility in previous generations. Some embodiments herein capture whether the decision for the mobility event was in line with the source node's policy. Furthermore, some embodiments herein safeguard against attacks from the air interface, which is more accessible than the internal connections in a network. Furthermore, some embodiments are applicable even in procedures where the communication device's context 14 is moved from a node to node without involving the communication device 12. An example of this kind of mobility is Radio Network Controller (RNC) relocations in 3G, which may be re-introduced in 6G for load balancing purposes.

Generally, then, some embodiments herein enable the delegator network node 16D owning a resource, controlled by the controller network node 16C, to reject a spurious assertion from yet another node that it now controls the resource 30. Some embodiments do so with a proof that cryptographically binds identifiers of the controller network node 16C and the assertee network node 16A to a transfer of the context 14, such that the delegator network node 16D can later verify that the transfer was intended by the controller network node 16C. The proof can be constructed in various ways as detailed herein, e.g., based on symmetric keys suitably arranged and combined with pseudorandom functions (PRFs), message authentication codes (MACs), or hash functions, or using asymmetric key signatures.

Note that the reason for the assertee network node 16A to send any assertion to the delegator network node 16D is for the delegator network node 16D to act on it, even if just logging it. This operation may also be included and is below referred to as operating on a resource, where the resource could be, e.g., a log or a registry or a set of user plane data flows.

Certain embodiments may provide one or more of the following technical advantage(s). Some embodiments herein improve security by preventing spurious reports or update requests from unknown sources. As a concrete example, if added to the X2/N2 handover procedure, some embodiments prevent a rogue entity on the network from asserting to have a UE handed over to it.

Some embodiments are nonetheless generic and could be applied for other situations as well in 3GPP networks, e.g., in service-based architecture (SBA) for signaling between AMF, SMF and other entities. If applied consistently in 6G, embodiments can provide a single well-studied method for securing these situations, instead of a bag of ad-hoc procedures for different cases. The latter is much more difficult to make secure and to analyze.

In some embodiments, for the delegator network node 16D to be certain that the assertee network node 16A indeed is the new controller of the context 14, the assertee network node 16A provides the proof of transfer token 22 together with a request to modify the resource 30. The delegator network node 16D attempts to verify the proof of transfer token 22. If the verification is successful, the delegator network node 16D can conclude that the controller network node 16C had decided to transfer control of the context 14 to the assertee network node 16A and operate on the resource 30 as requested.

Some embodiments in this regard utilize three communication procedures, referred to as the delegate procedure, the transfer procedure, and the assertion procedure. The delegator network node 16D delegates control of the context 14 to the controller network node 16C by executing the delegate procedure. This procedure ensures at least that the controller network node 16C is made aware of that it controls a context 14 identified by the context identifier 14-ID, also referred to as identifier ctxId. It can be expected that the controller network node 16C at the same time can access the context 14 itself, but this is not required.

The controller network node 16C decides to hand control of the context 14 over to the assertee network node 16A, identified by an assertee identifier 16A-ID (also referred to as asserteeId). The controller network node 16C computes the proof of transfer token 22 that binds the ctxId and the asserteeId together. The proof of transfer token 22 is made available to the assertee network node 16A using the transfer procedure.

Thereafter, if the assertee network node 16A wishes to notify the delegator network node 16D that it has taken control of the context 14, it provides the proof of transfer token 22 to the delegator network node 16D using the assertion procedure. Upon reception of the proof of transfer token 22, the delegator network node 16D can verify the proof of transfer token 22, and that it received the proof of transfer token 22 from the assertee network node 16A bound to the proof of transfer token 22. If verification is successful, the delegator network node 16D performs the operation on the resource 30. Note that verifying that the assertee network node 16A sending the proof of transfer token 22 is the assertee network node bound to the proof of transfer token 22 requires that the delegator network node 16D can verify the source of the assertion procedure. This can be achieved by either the assertee network node 16A signing the proof of transfer token 22, or that the proof of transfer token 22 is transmitted over a secure channel, providing authentication and message integrity. The secure channel can be instantiated using the IP Security (IPsec) protocol, Transport Layer Security (TLS), or Datagram TLS. Alternatively or additionally, the secure channel may be instantiated using 5G Core (5GC) SBA mechanisms.

Consider now some examples of the procedures according to some embodiments. Although the procedures are illustrated for example purposes as communicating single messages, the procedures may instead be multi-message procedures, potentially including other parties.

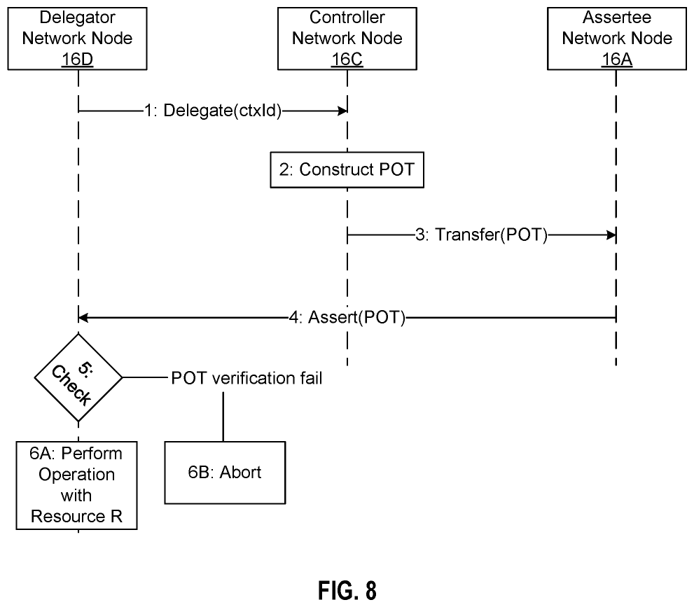

FIG. 8 shows the transfer procedure as a pure transfer of the POT from the controller network node 16c to the assertee network node 16A according to one example. In this example, the delegator network node 16D transmits a delegate message to the controller network node 16C, as an example of the delegation signaling 18 in FIG. 1, in order to delegate control of the context 14 to the controller network node 16C (Step 1). The delegate message includes the context identifier 14-ID of the context 14, shown as ctxId. The controller network node 16C thereafter constructs at least part of the POT token 22 (Step 2). In some embodiments where the controller network node 16C constructs only a part of the POT token 22, the delegator network node 16D or the assertee network node 16A may compute the other part. Regardless, the controller network node 16C transmits a transfer message to the assertee network node 16A in order to transfer control of the context 14 to the assertee network node 16A (Step 3). The transfer message is shown as including the POT token 22. Subsequently, the assertee network node 16A transmits an assertion message to the delegator network node 16D, making the assertion 26 that it now controls the context 14 (Step 4). The assertion message is shown as including the POT token 22. The delegator network node 16D correspondingly checks the POT token 22 as part of attempting to validate the POT token 22 (Step 5). If the validation succeeds, the delegator network node 16D performs an operation on the resource R associated with the context 14 (Step 6A). Otherwise, the delegator network node 16D aborts and does not perform the operation (Step 6B).

Note that, depending on how the POT token 22 is constructed, it may be possible to extract from the POT token 22 itself which ctxId, which controller identifier 16C-ID, and which assertee identifier 16A-ID it involves. These identifiers may be needed by the delegator network node 16D to verify the POT token 22 and the resource 30. However, the POT token 22 may alternatively be an opaque cryptographic object, in which case it may not be possible to extract one or more of these identifiers from it. In these embodiments, the transfer and assertion procedures may include the necessary identifiers in signaling thereof, outside of the POT token 22 e.g., the signaling between nodes may include the ctxId, and possibly the controller network node's identifier contId and/or the assertee network node's identifier asserteeId.

Note also that the POT token 22 in these embodiments is constructed by the controller network node 16C and is made available to the assertee network node 16A. Its purpose is to bind the context 14 to the assertee network node 16A in such a way that the delegator network node 16D can verify that this corresponds to a decision only the controller network node 16C could have made. It may be assumed that the delegator network node 16D is honest and does not generate a POT token 22 itself, even if this would be possible.

In some embodiments, there are two alternative types of POT tokens; namely, a symmetric key POT and an asymmetric key POT. An asymmetric key POT may include a signature over at least the context identifier ctxId and the assertee identifier asserteeId. In case the ctxId is generated fresh for every delegation, the delegator network node 16D can verify the signature and be certain that, if it is valid, the controller network node 16C decided to transfer the context 14. How the delegator network node 16D learns that the public key used for verification of the POT token 22 belongs to the controller network node 16C is out of scope. That can be handled via standard techniques, such as public key infrastructures or pre-provisioning of public keys.

If the context identifier is not generated fresh for every delegation, the delegator network node 16D may combine it with an increasing sequence number or a sufficiently large random value that makes it unlikely that the combination would repeat during system operation. If one of these two approaches is used, the delegator network node 16D must be able to verify the freshness during the assertion procedure, e.g., by storing the pair when running the delegation procedure.

Symmetric key based POTs require more complex handling. Specifically, the POT token 22 must be generated using a symmetric key known to the delegator network node 16D. This can be achieved in several ways.

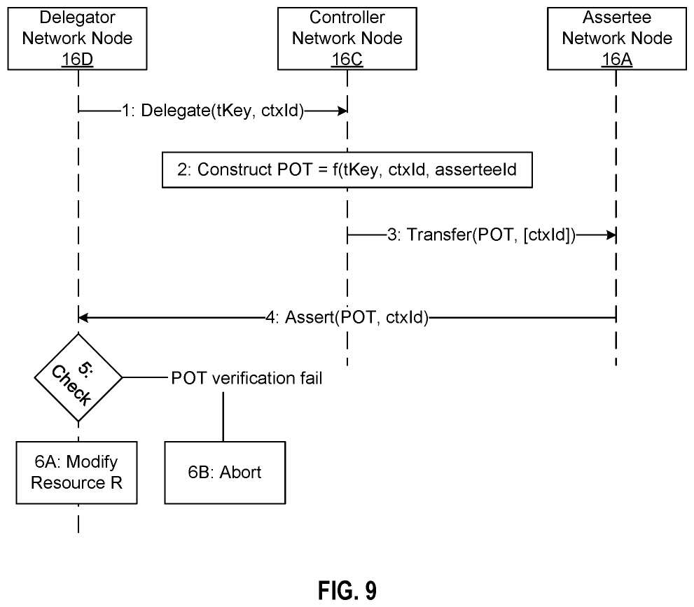

In a first embodiment shown in FIG. 9, the delegator network node 16D additionally transmits a transfer key tKey in the delegate procedure to the controller network node 16C (Step 1). In some embodiments, the tKey is encrypted (and possibly integrity protected) during transmission to the controller network node 16C. The encryption and integrity protection may be provided by a secure channel, such as IPsec or (D)TLS. The delegator network node 16D may then store, either locally or in a remote storage, the tKey so that it can be retrieved later with the ctxId and used for validation of the POT token 22.

Provided with the transfer key tKey, the controller network node 16C in some embodiments then computes the POT token 22 by applying a function f to at least the tKey, the ctxId and the asserteeId, e.g., POT token=f(tKey, ctxId, asserteeId). As an option, there may be further parameters specific to the use case input to f. The function f may be a finite pseudorandom function (PRF). It could alternatively be a key derivation function (KDF), a one-way function, or any function such that it is believed difficult to predict its output if a sufficiently large part of its input is unknown. A concrete example of such functions is the hash-based MAC function HMAC-SHA256, using a 256-bit tKey as key input.

In any event, the POT token 22 is made available to the assertee network node 16A in the transfer procedure, and so is the ctxId unless it is known to the assertee network node 16A in other ways. This conditional inclusion is shown by square brackets [ctxId] in FIG. 9. The assertee network node 16A then forwards the POT token 22 and the ctxId to the delegator network node 16D. Upon reading the ctxId, and knowing that it was received from an assertee network node 16A identified with identifier asserteeId, the delegator network node 16D verifies the POT token 22 by retrieving the tKey, computing f(tKey, ctxId, asserteeId), and comparing the result to the POT token 22 for equality. If they are the same, verification succeeded.

Consider now additional details of embodiments that exploit a proof of delegation token 60. These embodiments enable the delegator network node 16D to verify that it at an earlier time indeed did delegate control of the context 14 to the controller network node 16C. This may be useful if the delegator network node 16D cannot or does not wish to store that information, e.g., due to limited storage or to be able to verify a POT token 22 after a restart where the information about performed delegations has been lost. In this case, the delegator network node 16D provides a Proof Of Delegation (POD) token 60 to the controller network node 16C. When the controller network node 16C transfers control of the context 14 to the assertee network node 16A, the controller network node 16C cryptographically binds the POD token 60 to the POT token 22. Based on the POT token 22 in the report later received by the delegator network node 16D, the delegator network node 16D verifies the POD token 60. This verification may implicitly follow from verifying the POT token 22.

This construction requires a method for computing the POD token 60, a method for binding the POD token 60 to the POT token 22, and a method for verifying the POD token 60.

The POD token 60 can be bound to the POT token 22 in any of several ways. Using asymmetric key cryptography, for example, the delegator network node 16D may sign the combination of the context identifier 14-ID and the controller identifier 16C-ID. The combination may be, e.g., concatenation or hashing the concatenation of the two. Other information may be included in the combination as well, e.g., timestamps. The signature may be computed with a key such that the controller network node 16C can later verify the signature. For example, the controller network node's own signature key may be used.

Using symmetric key cryptography, as a different example, the controller network node 16C may instead apply a function with the same characteristics as the function f discussed above. The function f itself may even be used. It will be referred to as the function f in the following for illustrative purposes, but it may be different from f itself. The controller network node 16C may compute the POD token 60 as the output of f when given the combination of the context identifier 14-ID and controller identifier 16C-ID discussed above, but where in addition, a symmetric key dKey is added to the combination. A concrete example is that the POD token 60 equals f(dKey, ctxId∥contId), where f is HMAC-SHA256 and ∥ denotes concatenation. The dKey is preferably accessible to the delegator network node 16D when verifying the POT token 22. The delegator network node 16D may store the dKey locally or in a remote storage for this purpose. The delegator network node 16D may derive the dKey from another key that it stores.

For a stronger and more explicit connection to the transfer, the identifier of the controller, conId, may also be input to the signature algorithm or f.

The controller network node 16C may bind the POD token 60 to the POT token 22 in any of several ways. If the POT token 22 is computed as a signature (see above), then the controller network node 16C may include the POD token 60 in the scope of the signature calculation. The controller network node 16C may then transfer the POD token 60 to the assertee network node 16A together with the POT token 22, or as a part of the POT token 22 itself. The latter would mean that the POT token 22 can be viewed as a two-component entity, one of the components being the signature and the other being the POD token 60. In this case, then, part of the POT token 22 (the POD token 60) is computed by the delegator network node 16D and the other part of the POT token 22 (the signature) is computed by the controller network node 16C.

Similarly, the POD token 60 may be bound to the POT token 22 using a symmetric key. In this case, the POT token 22 can be computed as described above but where the POD token 60 is also part of the input to the function f, e.g., POT=f(tKey, ctxId, asserteeId, POD).

In the asymmetric key case, though, when receiving the report from an assertee, network node 16A containing a POT token 22 and a POD token 60, the POD token 60 possibly being part of the POT token 22, the delegator network node 16D verifies the signature binding the POD token 60 to the POT token 22. In the symmetric key case, the delegator network node 16D may obtain/tKey and compute the function f for the corresponding inputs. If the result matches the received POT token 22, the verification is successful.

The controller network node 16C in some embodiments verifies the POD token 60 and the POT token 22, either by verifying the corresponding signature, or by obtaining the corresponding key, dKey or tKey respectively, computing the f function over the relevant input and comparing the result to the received POD/POT token.

Note that the delegator network node 16D may send an identifier for the POD token 60, podId, together with the POD token 60 to the controller network node 16C, and store the POD, or sufficient information to later restore the POD token. The podId may be, e.g., a hash of the POD token 60, an integer, or a random value. The controller network node 16C would then compute the POT token 22 as above, except that it transfers the podId instead of the POD token 60 to the assertee network node 16A. When the delegator network node 16D receives the POT token 22, it uses the podId to reconstruct or retrieve the POD token 60 before proceeding with the verification of the POT token 22. This process reduces the amount of data sent between the controller network node 16A and the assertee network node 16A, and between the assertee network node 16A and the delegator network node 16D.

Some embodiments herein guard against the attacks possible in current networks, where a malicious NF sends fake requests to other NFs trying to guess the ID of a resource. Some embodiments in this regard cryptographically protect the resource with a proof of transfer token 22, perhaps in combination with an approach that makes it difficult to fool the controller into believing one is authorized to affect the resource, in a controlled and strong sense.

Note that embodiments herein protect the delegator network node 16D from spurious requests for operating on the resource 30. This is a separate problem from whether the controller network node 16C correctly decided to transfer the context 14 according to a given security policy. For example, in case the decision is based on an artificial intelligence prediction on the traffic patterns in the communication network 10, an adversary may influence the decision by data-poisoning, causing the controller network node 16C to decide to transfer the context 14 to a certain assertee network node 16A.

In some embodiments, the delegator network node 16D stores contexts, keys, and/or other identifiers in a remote storage.

Some embodiments herein are applicable to an Open Radio Access Network (O-RAN) implementation of the communication network 10. For example, in some embodiments, the context 14 may be transferred between different O-RAN entities, where the O-RAN entities may for example include Service Management Orchestration (SMO) entities, RAN controllers (RICs), Non-real-time RICs (non-RT RICs), near-real-time RICs (Near-RT RICs), Open Central Unit Control Plane (O-CU-CP) entities, Open Central Unit User Plane (O-CU-UP) entities, Open Distribute Units (O-Dus), Open Radio Units (O-RUs), etc., where the old entity is taking the role of the controller network node 16C and the new entity taking the role of assertee network node 16A and there is a need to update another entity (delegator network node 16D) over any O-RAN

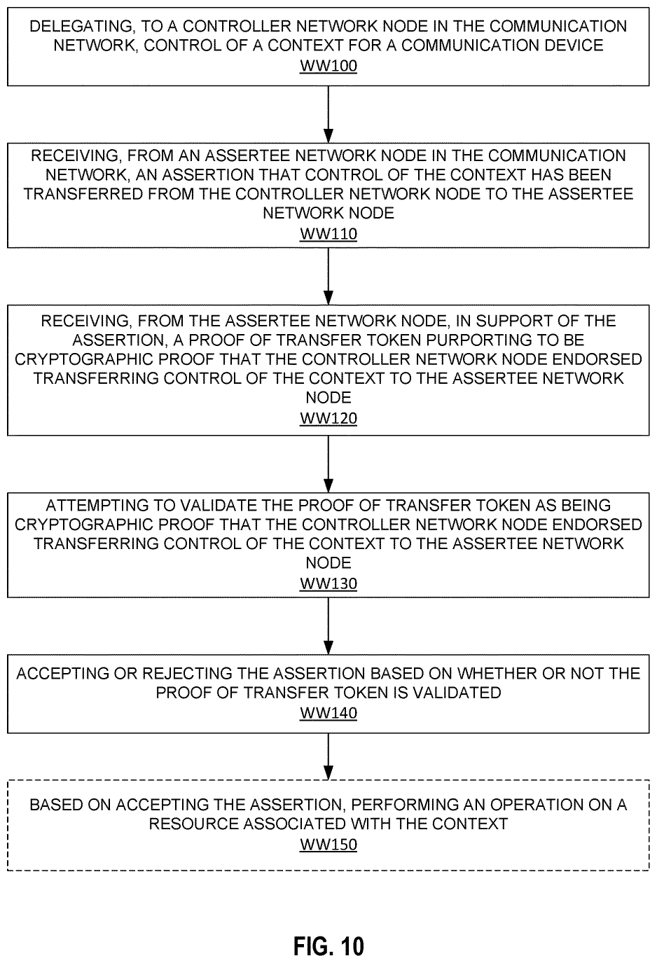

In view of the modifications and variations herein, FIG. 10 depicts a method performed by a delegator network node 16D in a communication network 10 in accordance with particular embodiments. The method includes delegating, to a controller network node 16C in the communication network 10, control of a context 14 for a communication device 12 (Block 100). The method also includes receiving, from an assertee network node 16A in the communication network 10, an assertion 26 that control of the context 14 has been transferred from the controller network node 16C to the assertee network node 16A (Block 110). The method also includes receiving, from the assertee network node 16A, in support of the assertion 26, a proof of transfer token 22 purporting to be cryptographic proof that the controller network node 16C endorsed transferring control of the context 14 to the assertee network node 16A (Block 120). The method also includes attempting to validate the proof of transfer token 22 as being cryptographic proof that the controller network node 16C endorsed transferring control of the context 14 to the assertee network node 16A (Block 130). The method also includes accepting or rejecting the assertion 26 based on whether or not the proof of transfer token 22 is validated (Block 140).

In some embodiments, the method further includes, based on accepting the assertion 26, performing an operation on a resource 30 associated with the context 14 (Block 150). In some embodiments, the method includes receiving, from the assertee network node 16A, a request for the delegator network node 16D to perform the operation on the resource 30 associated with the context 14, wherein the proof of transfer token 22 is included in the request.

In some embodiments, attempting to validate the proof of transfer token 22 comprises attempting to validate the proof of transfer token 22 as being a cryptographic binding 32, endorsed by the controller network node 16C, between an identifier 14-ID of the context 14 and an identifier 16C-ID of the assertee network node 16A.

In some embodiments, the method includes obtaining a proof of delegation token purporting to be cryptographic proof that the delegator network node 16D delegated control of the context 14 to the controller network node 16C. In one such embodiment, the method includes attempting to validate the proof of delegation token as being cryptographic proof that the delegator network node 16D delegated control of the context 14 to the controller network node 16C, separately from or as part of attempting to validate the proof of transfer token 22.

In some embodiments, attempting to validate the proof of transfer token 22 comprises attempting to validate that the proof of transfer token 22 is cryptographically bound to the same context 14 whose control is asserted by the assertion 26. In some embodiments, attempting to validate the proof of transfer token 22 comprises attempting to validate that the proof of transfer token 22 is cryptographically bound to the same assertee network node 16A from whom the assertion 26 and the proof of transfer token 22 are received. In some embodiments, attempting to validate the proof of transfer token 22 comprises attempting to validate that the proof of transfer token 22 was endorsed by the same controller network node 16C to whom control of the context 14 was delegated. In some embodiments, attempting to validate that the proof of transfer token 22 was endorsed by the same controller network node 16C to whom control of the context 14 was delegated comprises attempting to validate that the proof of transfer token 22 was cryptographically signed by the same controller network node 16C to whom control of the context 14 was delegated. In some embodiments, attempting to validate that the proof of transfer token 22 was cryptographically signed by the same controller network node 16C to whom control of the context 14 was delegated comprises attempting to validate that the proof of transfer token 22 was cryptographically signed by the controller network node 16C. In some embodiments, validating that the proof of transfer token 22 was cryptographically signed by the controller network node 16C uses a public key of the controller network node 16C. In other embodiments, validating that the proof of transfer token 22 was cryptographically signed by the controller network node 16C uses a symmetric key provided to the controller network node 16C and obtainable by the delegator network node 16D in association with an identifier 14-ID of the context 14. In some embodiments, attempting to validate that the proof of transfer token 22 is cryptographically bound to the same assertee network node 16A from whom the assertion 26 and the proof of transfer token 22 are received comprises attempting to validate that the proof of transfer token 22 was cryptographically signed by the same assertee network node 16A from whom the assertion 26 and the proof of transfer token 22 were received. In other embodiments, attempting to validate that the proof of transfer token 22 is cryptographically bound to the same assertee network node 16A from whom the assertion 26 and the proof of transfer token 22 are received comprises attempting to validate that the proof of transfer token 22 was received over a secure channel associated with the same assertee network node 16A from whom the assertion 26 and the proof of transfer token 22 were received.

In some embodiments, accepting or rejecting the assertion 26 comprises accepting or rejecting the assertion 26 based also on whether or not the proof of delegation token is validated.

In some embodiments, attempting to validate the proof of transfer token 22 comprises obtaining inputs that include a context identifier 14-ID identifying the context 14 whose control is asserted by the assertion 26 and an assertee identifier 16A-ID identifying the assertee network node 16A to whom control of the context 14 has been transferred according to the assertion 26. In some embodiments, attempting to validate the proof of transfer token 22 also comprises obtaining a cryptographic key 38 that is associated with the context 14, that is associated with the controller network node 16C to whom control of the context 14 was transferred, or that accompanies the proof of transfer token 22. In some embodiments, attempting to validate the proof of transfer token 22 further comprises generating a test value as a function of the inputs 14-ID, 16A-ID and the cryptographic key 38. In some embodiments, attempting to validate the proof of transfer token 22 then comprises obtaining an expected value from the proof of transfer token 22. In some embodiments, attempting to validate the proof of transfer token 22 then comprises validating or invalidating the proof of transfer token 22 based respectively on whether or not the test value matches the expected value.

In some embodiments, the inputs 14-ID, 16A-ID also include a proof of delegation token purporting to be cryptographic proof that the delegator network node 16D delegated control of the context 14 to the controller network node 16C. In some embodiments, generating the test value comprises computing a cryptographic signature 36 over the inputs 14-ID, 16A-ID using the cryptographic key 38. In some embodiments, the inputs 14-ID, 16A-ID also include a controller identifier 16C-ID identifying the controller network node 16C from which control of the context 14 was transferred according to the assertion 26.

In some embodiments, the resource 30 is a user plane traffic flow for the communication device 12 or a control plane session for the communication device 12. In some embodiments, the operation on the resource 30 includes redirecting the resource 30 from the controller network node 16C to the assertee network node 16A. In some embodiments, the resource 30 is a log or registry at the delegator network node 16D, and wherein the operation on the resource 30 includes logging, on the resource 30, transfer of control of the context 14 to the assertee network node 16A.

In some embodiments, the delegator network node 16D implements a Session Management Function, SMF, serving the communication device 12, and the controller network node 16C and the assertee network node 16A each implement a respective Access and Mobility Management Function, AMF. In other embodiments, the delegator network node 16D implements a core network node serving the communication device 12, and the controller network node 16C and the assertee network node 16A are each an access network node.

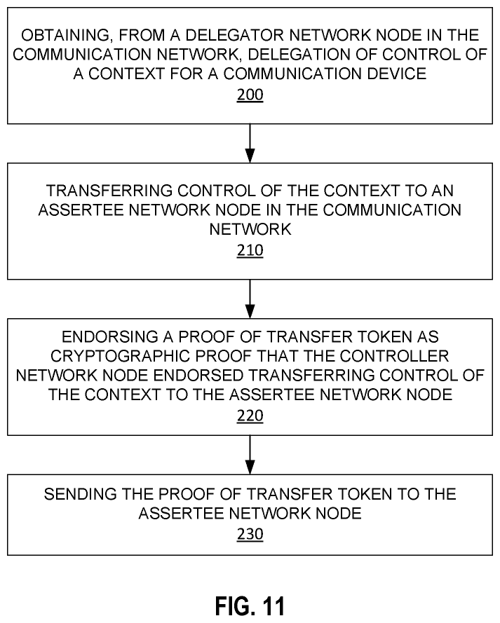

FIG. 11 depicts a method performed by a controller network node 16C in a communication network 10 in accordance with other particular embodiments. The method includes obtaining, from a delegator network node 16D in the communication network 10, delegation of control of a context 14 for a communication device 12 (Block 200). The method also includes transferring control of the context 14 to an assertee network node 16A in the communication network 10 (Block 210). The method also includes endorsing a proof of transfer token 22 as cryptographic proof that the controller network node 16C endorsed transferring control of the context 14 to the assertee network node 16A (Block 220). The method also includes sending the proof of transfer token 22 to the assertee network node 16A (Block 230).

In some embodiments, the method further includes obtaining a proof of delegation token purporting to be cryptographic proof that the delegator network node 16D delegated control of the context 14 to the controller network node 16C. In some embodiments, endorsing the proof of transfer token 22 comprises endorsing the proof of transfer token 22 using the proof of delegation token. In other embodiments, the method further includes sending the proof of delegation token to the assertee network node 16A.

In some embodiments, endorsing the proof of transfer token 22 comprises endorsing the proof of transfer token 22 as a cryptographic binding 32 between an identifier 14-ID of the context 14 and an identifier 16C-ID of the assertee network node 16A.

In some embodiments, endorsing the proof of transfer token 22 comprises cryptographically signing the proof of transfer token 22. In some embodiments, cryptographically signing the proof of transfer token 22 comprises cryptographically signing the proof of transfer token 22 using a private key of the controller network node 16C. In other embodiments, cryptographically signing the proof of transfer token 22 comprises cryptographically signing the proof of transfer token 22 using a symmetric key that the controller network node 16C provides to the assertee network node 16A.

In some embodiments, endorsing the proof of transfer token 22 comprises obtaining inputs that include a context identifier 14-ID identifying the context 14 and an assertee identifier 16A-ID identifying the assertee network node 16A. In some embodiments, endorsing the proof of transfer token 22 comprises obtaining a cryptographic key 38 that is associated with the context 14, that is associated with the controller network node 16C, or that is received from the delegator network node 16D. In some embodiments, endorsing the proof of transfer token 22 comprises endorsing the proof of transfer token 22 as a function of the inputs 14-ID, 16A-ID and the cryptographic key 38. In some embodiments, the inputs 14-ID, 16A-ID also include a proof of delegation token as cryptographic proof that the delegator network node 16D delegated control of the context 14 to the controller network node 16C. In some embodiments, endorsing the proof of transfer token 22 comprises computing a cryptographic signature 36 over the inputs 14-ID, 16A-ID using the cryptographic key 38.

In some embodiments, the delegator network node 16D implements a Session Management Function, SMF, serving the communication device 12, and the controller network node 16C and the assertee network node 16A each implement a respective Access and Mobility Management Function, AMF. In other embodiments, the delegator network node 16D implements a core network node serving the communication device 12, and the controller network node 16C and the assertee network node 16A are each an access network node.

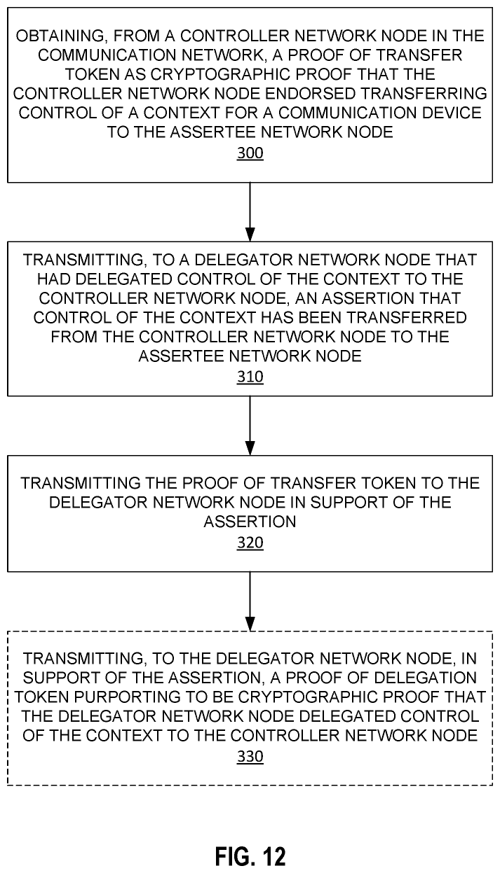

FIG. 12 depicts a method performed by an assertee network node 16A in a communication network 10 in accordance with other particular embodiments. The method includes obtaining, from a controller network node 16C in the communication network 10, a proof of transfer token 22 as cryptographic proof that the controller network node 16C endorsed transferring control of a context 14 for a communication device 12 to the assertee network node 16A (Block 300). The method also includes transmitting, to a delegator network node 16D that had delegated control of the context 14 to the controller network node 16C, an assertion 26 that control of the context 14 has been transferred from the controller network node 16C to the assertee network node 16A (Block 310). The method also includes transmitting the proof of transfer token 22 to the delegator network node 16D in support of the assertion 26 (Block 320).

In some embodiments, the method includes transmitting, to the delegator network node 16D, in support of the assertion 26, a proof of delegation token purporting to be cryptographic proof that the delegator network node 16D delegated control of the context 14 to the controller network node 16C (Block 330).

In some embodiments, the proof of transfer token 22 comprises a cryptographic binding 32, created or endorsed by the controller network node 16C, between an identifier 14-ID of the context 14 and an identifier 16C-ID of the assertee network node 16A.

In some embodiments, transmitting the proof of transfer token 22 to the delegator network node 16D comprises transmitting the proof of transfer token 22 to the delegator network node 16D in a request for the delegator network node 16D to perform an operation on a resource 30 associated with the context 14. In some embodiments, the resource 30 is a user plane traffic flow for the communication device 12 or a control plane session for the communication device 12. In some embodiments, the operation on the resource 30 includes redirecting the resource 30 from the controller network node 16C to the assertee network node 16A. In some embodiments, the resource 30 is a log or registry at the delegator network node 16D, and the operation on the resource 30 includes logging, on the resource 30, transfer of control of the context 14 to the assertee network node 16A.

In some embodiments, the delegator network node 16D implements a Session Management Function, SMF, serving the communication device 12, and wherein the controller network node 16C and the assertee network node 16A each implement a respective Access and Mobility Management Function, AMF. In other embodiments, the delegator network node 16D implements a core network node serving the communication device 12, and wherein the controller network node 16C and the assertee network node 16A are each an access network node.

Embodiments herein also include corresponding apparatuses. Embodiments herein for instance include a network node 16D, 16C, or 16A configured to perform any of the steps of any of the embodiments described above for the network node 16D, 16C, or 16A.

Embodiments also include a network node 16D, 16C, or 16A comprising processing circuitry and power supply circuitry. The processing circuitry is configured to perform any of the steps of any of the embodiments described above for the network node 16D, 16C, or 16A. The power supply circuitry is configured to supply power to the network node 16D, 16C, or 16A.

Embodiments further include a network node 16D, 16C, or 16A comprising processing circuitry. The processing circuitry is configured to perform any of the steps of any of the embodiments described above for the network node 16D, 16C, or 16A. In some embodiments, the network node 16D, 16C, or 16A further comprises communication circuitry.

Embodiments further include a network node 16D, 16C, or 16A comprising processing circuitry and memory. The memory contains instructions executable by the processing circuitry whereby the network node 16D, 16C, or 16A is configured to perform any of the steps of any of the embodiments described above for the network node 16D, 16C, or 16A.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

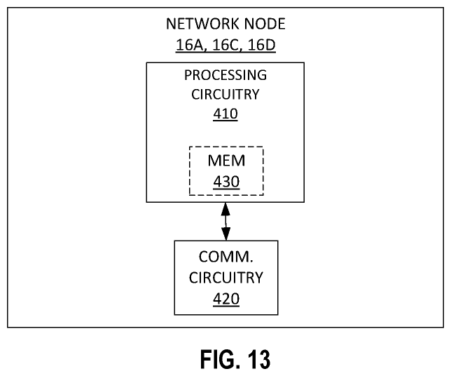

FIG. 13 for example illustrates a network node 16D, 16C, or 16A as implemented in accordance with one or more embodiments. The network node network node 16D, 16C, or 16A corresponds to the delegator network node 16D, the controller network node 16C, or the assertee network node 16A herein. As shown, the network node 16D, 16C, or 16A includes processing circuitry 410 and communication circuitry 420. The communication circuitry 420 (e.g., radio circuitry) is configured to transmit and/or receive information to and/or from one or more other nodes, e.g., via any communication technology. The processing circuitry 410 is configured to perform processing described above, e.g., in FIG. 10, 11, or 12, such as by executing instructions stored in memory 430. The processing circuitry 410 in this regard may implement certain functional means, units, or modules.

Those skilled in the art will also appreciate that embodiments herein further include corresponding computer programs.

A computer program comprises instructions which, when executed on at least one processor of a network node 16D, 16C, or 16A, cause the network node 16D, 16C, or 16A to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of a network node 16D, 16C, or 16A, cause the network node 16D, 16C, or 16A to perform as described above.

Embodiments further include a computer program product comprising program code portions for performing the steps of any of the embodiments herein when the computer program product is executed by a network node 16D, 16C, or 16A. This computer program product may be stored on a computer readable recording medium.

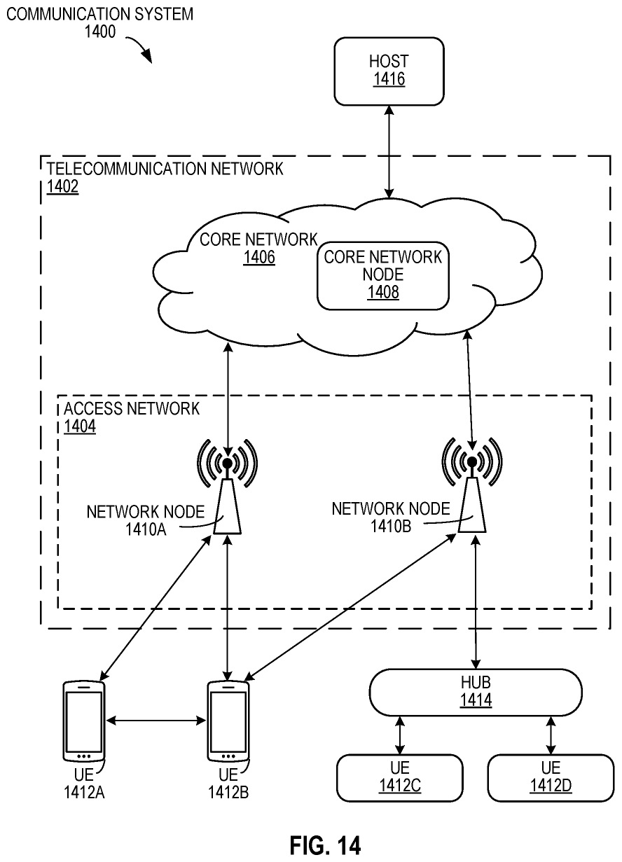

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1402 includes one or more Open-RAN (ORAN) network nodes. An ORAN network node is a node in the telecommunication network 1402 that supports an ORAN specification (e.g., a specification published by the O-RAN Alliance, or any similar organization) and may operate alone or together with other nodes to implement one or more functionalities of any node in the telecommunication network 1402, including one or more network nodes 1410 and/or core network nodes 1408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

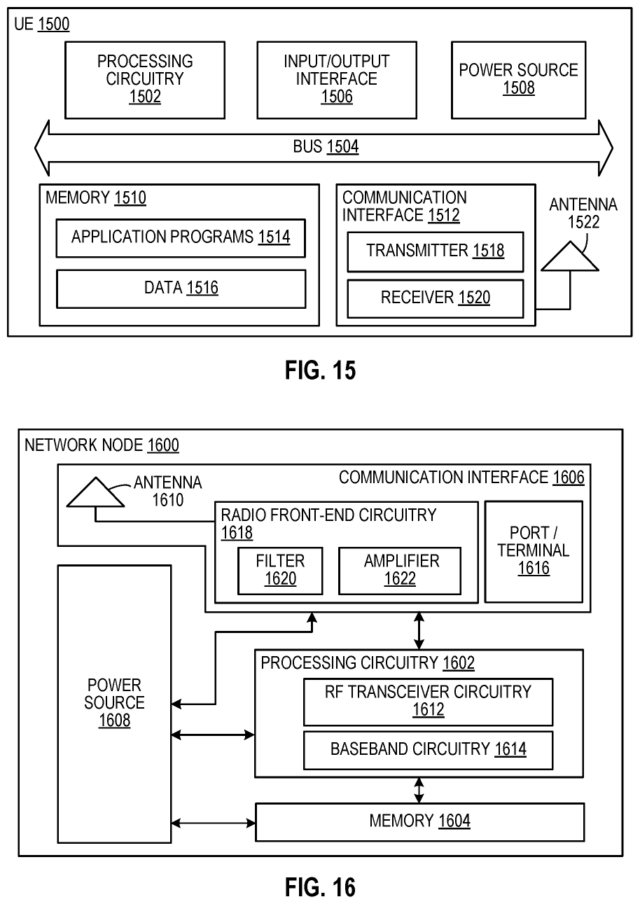

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

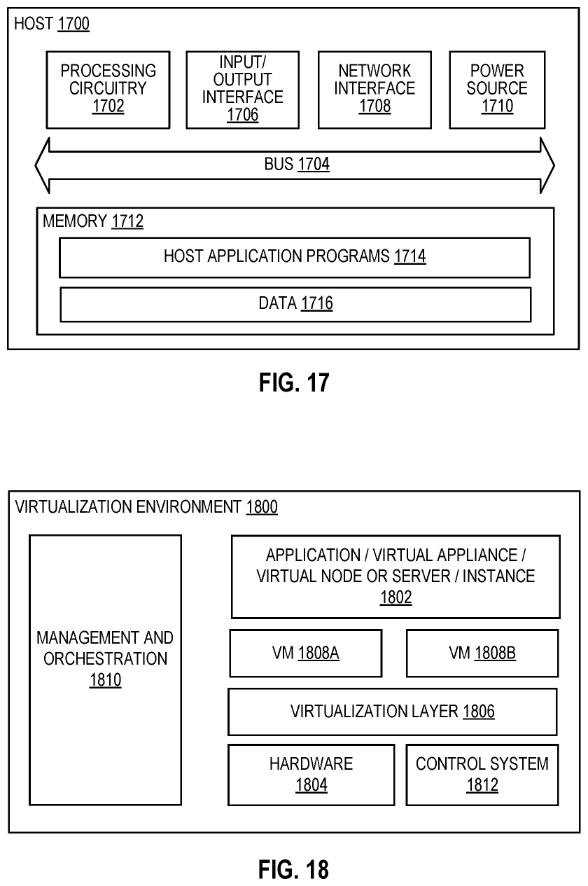

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any network node 16A, 16C, or 16D described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1800 includes components defined by the O-RAN Alliance, such as an O-Cloud environment orchestrated by a Service Management and Orchestration Framework via an O-2 interface.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

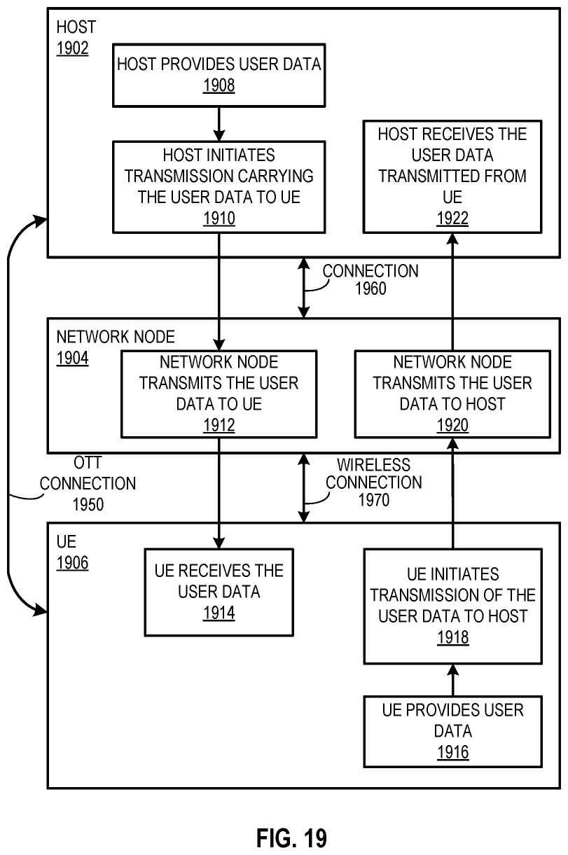

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Note that any of the network nodes 16A, 16C, or 16D herein may be realized with network functionality that is disaggregated and/or distributed. Any of the network nodes 16A, 16C, or 16D may for example be realized as at least one software container, the container managed by a containerized application orchestration platform and executing on a server of a set of servers for providing the functionality described above.

As another example, any of the network nodes 16A, 16C, or 16D may be realized as at least one virtual machine orchestrated by a hypervisor and executing on a server of a set of servers for providing the functionality described above.

As another example, any of the network nodes 16A, 16C, or 16D may be realized with a system of containers or virtual machines, the system comprised of at least one processor and at least one memory, the at least one processor and the at least one memory resident on a server or a set of servers, the at least one memory storing instructions that, when executed by the at least one processor on the server or set of servers, causing the system to perform as described above.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

1.-40. (canceled)

41. A method performed by a delegator network node in a communication network, the method comprising:
delegating, to a controller network node in the communication network, control of a context for a communication device;
receiving, from an assertee network node in the communication network, an assertion that control of the context has been transferred from the controller network node to the assertee network node;
receiving, from the assertee network node, in support of the assertion, a proof of transfer token purporting to be cryptographic proof that the controller network node endorsed transferring control of the context to the assertee network node;
attempting to validate the proof of transfer token as being cryptographic proof that the controller network node endorsed transferring control of the context to the assertee network node; and
accepting or rejecting the assertion based on whether or not the proof of transfer token is validated.

42. The method of claim 41, wherein attempting to validate the proof of transfer token comprises attempting to validate the proof of transfer token as being a cryptographic binding, endorsed by the controller network node, between an identifier of the context and an identifier of the assertee network node.

43. The method of claim 41, wherein attempting to validate the proof of transfer token comprises attempting to validate that:
the proof of transfer token is cryptographically bound to the same context whose control is asserted by the assertion;
the proof of transfer token is cryptographically bound to the same assertee network node from whom the assertion and the proof of transfer token are received; and
the proof of transfer token was endorsed by the same controller network node to whom control of the context was delegated. (New) The method of claim 43, wherein:
attempting to validate that the proof of transfer token was endorsed by the same controller network node to whom control of the context was delegated comprises attempting to validate that the proof of transfer token was cryptographically signed by the same controller network node to whom control of the context was delegated; and/or
attempting to validate that the proof of transfer token is cryptographically bound to the same assertee network node from whom the assertion and the proof of transfer token are received comprises attempting to validate that:
the proof of transfer token was cryptographically signed by the same assertee network node from whom the assertion and the proof of transfer token were received; or
the proof of transfer token was received over a secure channel associated with the same assertee network node from whom the assertion and the proof of transfer token were received.

45. The method of claim 41, further comprising:
obtaining a proof of delegation token purporting to be cryptographic proof that the delegator network node delegated control of the context to the controller network node; and
attempting to validate the proof of delegation token as being cryptographic proof that the delegator network node delegated control of the context to the controller network node, separately from or as part of attempting to validate the proof of transfer token;
wherein accepting or rejecting the assertion comprises accepting or rejecting the assertion based also on whether or not the proof of delegation token is validated.

46. The method of claim 41, wherein attempting to validate the proof of transfer token comprises:
obtaining inputs that include a context identifier identifying the context whose control is asserted by the assertion and an assertee identifier identifying the assertee network node to whom control of the context has been transferred according to the assertion;
obtaining a cryptographic key that is associated with the context, that is associated with the controller network node to whom control of the context was transferred, or that accompanies the proof of transfer token;
generating a test value as a function of the inputs and the cryptographic key;
obtaining an expected value from the proof of transfer token; and
validating or invalidating the proof of transfer token based respectively on whether or not the test value matches the expected value.

47. The method of claim 41, further comprising:
receiving, from the assertee network node, a request for the delegator network node to perform an operation on a resource associated with the context, wherein the proof of transfer token is included in the request; and
based on accepting the assertion, performing the operation on the resource associated with the context.

48. The method of claim 47, wherein:
the resource is a user plane traffic flow for the communication device or a control plane session for the communication device, and the operation on the resource includes redirecting the resource from the controller network node to the assertee network node; or
the resource is a log or registry at the delegator network node, and the operation on the resource includes logging, on the resource, transfer of control of the context to the assertee network node.

49. The method of claim 41, wherein:
the delegator network node implements a Session Management Function (SMF) serving the communication device, and wherein the controller network node and the assertee network node each implement a respective Access and Mobility Management Function (AMF); or
the delegator network node implements a core network node serving the communication device, and wherein the controller network node and the assertee network node are each an access network node.

50. A method performed by a controller network node in a communication network, the method comprising:
obtaining, from a delegator network node in the communication network, delegation of control of a context for a communication device;
transferring control of the context to an assertee network node in the communication network;
endorsing a proof of transfer token as cryptographic proof that the controller network node endorsed transferring control of the context to the assertee network node; and
sending the proof of transfer token to the assertee network node.

51. The method of claim 50, wherein endorsing the proof of transfer token comprises:
endorsing the proof of transfer token as a cryptographic binding between an identifier of the context and an identifier of the assertee network node; and/or
cryptographically signing the proof of transfer token.

52. The method of claim 50, further comprising obtaining a proof of delegation token purporting to be cryptographic proof that the delegator network node delegated control of the context to the controller network node, and wherein either:
endorsing the proof of transfer token comprises endorsing the proof of transfer token using the proof of delegation token; or
the method further comprises sending the proof of delegation token to the assertee network node.

53. The method of claim 50, wherein endorsing the proof of transfer token comprises:
obtaining inputs that include a context identifier identifying the context and an assertee identifier identifying the assertee network node;
obtaining a cryptographic key that is associated with the context, that is associated with the controller network node, or that is received from the delegator network node; and
endorsing the proof of transfer token as a function of the inputs and the cryptographic key.

54. The method of claim 50, wherein.
the delegator network node implements a Session Management Function (SMF) serving the communication device, and wherein the controller network node and the assertee network node each implement a respective Access and Mobility Management Function (AMF); or
the delegator network node implements a core network node serving the communication device, and wherein the controller network node and the assertee network node are each an access network node.

55. A method performed by an assertee network node in a communication network, the method comprising:
obtaining, from a controller network node in the communication network, a proof of transfer token as cryptographic proof that the controller network node endorsed transferring control of a context for a communication device to the assertee network node;
transmitting, to a delegator network node that had delegated control of the context to the controller network node, an assertion that control of the context has been transferred from the controller network node to the assertee network node; and
transmitting the proof of transfer token to the delegator network node in support of the assertion.

56. The method of claim 55, wherein the proof of transfer token comprises a cryptographic binding, created or endorsed by the controller network node, between an identifier of the context and an identifier of the assertee network node.

57. The method of claim 55, further comprising transmitting, to the delegator network node, in support of the assertion, a proof of delegation token purporting to be cryptographic proof that the delegator network node delegated control of the context to the controller network node.

58. The method of claim 55, wherein transmitting the proof of transfer token to the delegator network node comprises transmitting the proof of transfer token to the delegator network node in a request for the delegator network node to perform an operation on a resource associated with the context.

59. The method of claim 58, wherein:
the resource is a user plane traffic flow for the communication device or a control plane session for the communication device, and the operation on the resource includes redirecting the resource from the controller network node to the assertee network node; or
the resource is a log or registry at the delegator network node, and wherein the operation on the resource includes logging, on the resource, transfer of control of the context to the assertee network node.

60. A delegator network node in a communication network, the delegator network node comprising:
communication circuitry; and
processing circuitry configured to:
delegate, to a controller network node in the communication network, control of a context for a communication device;
receive, from an assertee network node in the communication network, an assertion that control of the context has been transferred from the controller network node to the assertee network node;
receive, from the assertee network node, in support of the assertion, a proof of transfer token purporting to be cryptographic proof that the controller network node endorsed transferring control of the context to the assertee network node;
attempt to validate the proof of transfer token as being cryptographic proof that the controller network node endorsed transferring control of the context to the assertee network node; and
accept or reject the assertion based on whether or not the proof of transfer token is validated.
